(19) United States
(12) Patent Application Publication
(10) Pub. No.: US 2023/0149312 A1
(43) Pub. Date: May 18, 2023

(54) MODIFIED RELEASE PHARMACEUTICAL FORMULATION COMPRISING HYDROXYPROPYL CELLULOSE

(71) Applicant: HERCULES LLC, Wilmington, DE (US)

(72) Inventors: Daiqiang XU, Hockessin, DE (US); Anitha CHAN, Wilmington, DE (US); Amol BATRA, Wilmington, DE (US); Ningyi Nick CHEN, Hockessin, DE (US)

(73) Assignee: HERCULES LLC, Wilmington, DE (US)

(21) Appl. No.: 17/920,690

(22) PCT Filed: Apr. 28, 2021
(86) PCT No.: PCT/US2021/209581

§ 371 Date: Oct. 21, 2022

Related U.S. Application Data
(60) Provisional application No. 63/019,109, filed on May 1, 2020.

(51) Int. Cl. A61K 9/16; A61K 31/549; A61K 31/192; A61K 9/20

(52) U.S. Cl. CPC A61K 9/1652; A61K 31/549; A61K 31/192; A61K 9/2054; A61K 9/2009; A61K 9/2018; A61K 9/2013

(57) ABSTRACT

The present disclosure relates to hydroxypropyl cellulose (HPC) having a molar substitution of from about 3.0 to about 3.9, a weight average molecular weight of from about 800,000 to about 2,000,000 Daltons, and a volume average particle size of less than 100 μm, and modified release formulations derived therefrom.

### FIELD OF THE INVENTION

The presently disclosed process(es), procedure(s), method(s), product(s), result(s), and/or concept(s) (collectively referred to hereinafter as the “present disclosure”) relates generally to hydroxypropyl cellulose (HPC) and applications thereof. The present disclosure further relates to a modified release pharmaceutical formulation(s) derived from the hydroxypropyl cellulose.

### BACKGROUND OF THE INVENTION

Pharmaceutical compositions often include polymers to achieve specific desired therapeutic effects, including for use as coating agents, film-formers, rate-controlling agents for modified release, stabilizing agents, suspending agents, tablet binders, and viscosity-increasing agents.

It has long been known that almost all pharmacologically active compounds are most effective when present in blood plasma within a certain concentration range and above this range may lead to deleterious side effects. Also, excess drug in the blood plasma may be wasted if the concentration is significantly above the recommended blood level that results in the maximum pharmacological effect, thus making both the manufacture and use of the drug formulation unnecessarily costly. Alternatively, when the concentration of drug in the plasma is below the most effective range, there is the danger that the active ingredient may not be maximally effective or may not be effective at all.

When physiologically possible, an oral dosage form is the preferred route of administration of most pharmaceutical compounds because it provides easy, low cost administration. However, patient compliance is a crucial factor to consider in conjunction with oral administration of a pharmaceutical compound, especially if the compound must be taken three or four times a day. To maximize patient compliance, it is desirable to reduce the number of daily dosage units a patient must take to attain effective therapy. The use of fewer, longer acting dosages also improves the constancy of drug concentrations in the blood over time, and since the drug can be closer to its ideal therapeutic dosage throughout the day, this may result in improved therapy.

One method of accomplishing these goals is using modified release formulations, which are effective in maintaining the therapeutic blood levels over extended periods of time resulting in optimal therapy. They not only reduce the frequency of dosing, but also reduce the severity and frequency of side effects, as they maintain substantially constant blood levels and avoid the fluctuations associated with the conventional immediate release formulations administered three to four times a day.

There are many different modified release dosage forms available commercially. Many of these modified delivery systems utilize hydrophilic, polymeric matrices that provide useful levels of control to deliver the drugs. After the formulation is ingested, the active pharmaceutical ingredient slowly releases from the polymer matrix, resulting in prolonged release of the active ingredient. One approach to formulating modified release compositions includes the dry blending of one or more polymers with the desired drug, forming a composition which, when exposed to fluid, forms a gel; the drug is then slowly released by diffusion from the gel.

Tablets have been prepared in the past which will modify the release of the contained medicine, but they have not been entirely satisfactory. Some of them have been too expensive to make either because of the expensive ingredients or the complicated apparatus or process to make them or they have been too large because of the necessary additives to obtain the delayed release. Other tablets have been unsatisfactory because they have lacked a uniform release time.

Another important consideration is that the material which causes the modified drug release must be physiologically acceptable. It must have no or a negligible toxic effect upon the person. It must be completely eliminated so that even during prolonged use it does not accumulate in a person's tissues. There exists a need for compositions and processes for making orally deliverable pharmaceutical formulations as modified release that overcomes the problem related to the processes discussed above.

### SUMMARY OF THE INVENTION

In one aspect, the present disclosure provides a hydroxypropyl cellulose (HPC) having a molar substitution of from about 3.0 to about 3.9, a weight average molecular weight of from about 700,000 to about 2,000,000 Daltons, and a volume average particle size of less than 100 microns. In one non-limiting embodiment of the present disclosure, the molar substitution of hydroxypropyl cellulose varies in the range of from about 3.2 to about 3.8, or from about 3.4 to about 3.7. In one non-limiting embodiment of the present disclosure, the weight average molecular weight of hydroxypropyl cellulose varies in the range of from about 1,000,000 to about 1,500,000 Daltons. In one non-limiting embodiment of the present disclosure, the hydroxypropyl cellulose has a viscosity of least 300 mPa·s in a 1 wt. % aqueous solution at 25° C. In another non-limiting embodiment of the present disclosure, the viscosity of hydroxypropyl cellulose can vary in the range of from about 1,000 to about 3,000 mPa·s in a 1 wt. % aqueous solution at 25° C.

In another aspect, the present disclosure provides a modified release formulation comprising hydroxypropyl cellulose having a molar substitution of from about 3.0 to about 3.9, a weight average molecular weight of from about 700,000 to about 2,000,000 Daltons, and a volume average particle size of less than 100 μm. In one non-limiting embodiment of the present disclosure, the molar substitution of hydroxypropyl cellulose varies in the range of from about 3.2 to about 3.8, or from about 3.4 to about 3.7. In one non-limiting embodiment of the present disclosure, the weight average molecular weight of hydroxypropyl cellulose varies in the range of from 1,000,000 to about 1,500,000 Daltons. The hydroxypropyl cellulose present in the modified release formulation of the present disclosure has a viscosity of at least 300 mPa·s. in a 1 wt. % aqueous solution at 25° C. In one non-limiting embodiment of the present disclosure, the viscosity of hydroxypropyl cellulose varies in the range of from about 1000 mPa·s to about 3000 mPa·s. in a 1 wt. % aqueous solution at 25° C.

In one non-limiting embodiment of the present disclosure, the amount of hydroxypropyl cellulose in the modified release formulation varies in the range of from about 5 wt. % to about 99 wt. %, or from about 10 wt. % to about 90 wt. %, or from about 15 wt. % to about 75 wt. % of the total formulation.

Further, the modified release formulation of the present disclosure also comprises a pharmaceutically effective amount of at least one drug having water solubility greater than 1 mg/L at 25° C. In one non-limiting embodiment of the present disclosure, the water solubility of the drug is greater than 20 mg/L, or greater than 700 mg/L.

In one non-limiting embodiment of the present disclosure, the drug is selected from the group consisting of antipyretic, analgesic and anti-inflammatory drugs, anthelmintic drugs, cardiovascular drugs, antibacterial drugs, bronchodilators, anti-asthmatic drugs, gastrointestinal drugs, antidiabetics, antiprotozoal drugs, antiviral drugs, anti-epileptic drugs, diuretics, or pharmaceutically acceptable salts and esters thereof.

In another non-limiting embodiment of the present disclosure, the drug is selected from the group consisting of etodolac, albendazole, ciprofloxacin, erythromycin and its derivative, ibuprofen, diclofenac, tofacitinib, carvedilol, metoprolol, sacubitril, valsartan, salbutamol, doxofylline, theophylline, cimetidine, omeprazole, metformin hydrochloride, sitagliptin, tinidazole, chlorothiazide, hydrochlorothiazide, acyclovir, carbamazepine, and their pharmaceutically acceptable salts and esters.

In another non-limiting embodiment, the modified release formulation of the present disclosure further comprises at least one pharmaceutically acceptable excipient selected from the group consisting of a filler, a binder, a surfactant, a disintegrating agent, a lubricant, and a flow aid. In one non-limiting embodiment of the present disclosure, the pharmaceutically acceptable excipient is a filler selected from the group consisting of monosaccharides, disaccharides, polysaccharides, and combinations thereof. In another non-limiting embodiment of the present disclosure, the filler is selected from the group consisting of cellulose, lactose, sucrose, sugars, starches, processed starches, mannitol, sorbitol, xylitol, lactitol, silicic acid, calcium sulfate, aluminum and magnesium silicate complexes and oxides, calcium diphosphate dihydrate and hydrosulfates.

In another non-limiting embodiment of the present disclosure, the pharmaceutically acceptable excipient is a lubricant selected from the group consisting of talc, calcium stearate, magnesium stearate, polyethylene glycol, stearic acid, colloidal silicon dioxide, calcium silicate, mineral oil, wax, hydrogenated vegetable oil, glyceryl behenate, sodium benzoate, sodium acetate, sodium stearyl fumarate and combinations thereof.

In another non-limiting embodiment of the present disclosure, the pharmaceutically acceptable excipient is a binder selected from the group consisting of polyvinyl pyrrolidone, sucrose, lactose, starch, processed starch, sugars, gum Arabic, tragacanth gum, guar gum, pectin, wax-based binders, microcrystalline cellulose (MCC), methyl cellulose, carboxymethyl cellulose, copovidone, gelatin, sodium alginate, hydroxypropyl methyl cellulose, hydroxyethyl cellulose and combinations thereof.

In one non-limiting embodiment of the present disclosure, the pharmaceutical acceptable excipient is present in an amount of from about 1 wt. % to about 85 wt. %, based on the total weight of the modified release formulation. In another non-limiting embodiment of the present disclosure, the modified release formulation is in the form of a tablet, a capsule, powder, granules, sachets, or lozenges.

### BRIEF DESCRIPTION OF THE FIGURES AND DRAWINGS

Objects, features, and advantages of the present invention will become apparent upon reading the following description in conjunction with the drawings/figures, in which:

FIG. 1 shows an NMR spectrum of a representative Hydroxypropyl cellulose sample.

FIG. 2 shows a dissolution profile of Hydrochlorothiazide (HCTZ) drug (as a % of the total drug released over 24 hours) present in the modified release formulation of Example 6 prepared by using 30 wt. % of Hydroxypropyl cellulose (HPC) of Example 1, and its comparison with a dissolution profile of HCTZ drug present in the Comparative modified release formulation of Example 6A prepared by using 30 wt. % of HPC of Comparative Example 5.

FIG. 3 shows a dissolution profile of Hydrochlorothiazide (HCTZ) drug (as a % of the total drug released over 24 hours) present in the modified release formulation of Example 7 prepared by using 60 wt. % of HPC of Example 1, and its comparison with a dissolution profile of HCTZ drug present in the Comparative modified release formulation of Example 7A prepared by using 30 wt. % of HPC of Comparative Example 5.

FIG. 4 shows a dissolution profile of Ibuprofen drug (as a % of the total drug released over 24 hours) present in the modified release formulation of Example 8 prepared by using 20 wt. % of HPC of Example 2, and its comparison with a dissolution profile of Ibuprofen drug present in the Comparative modified release formulation of Example 8A prepared by using 20 wt. % of HPC of Comparative Example 5.

FIG. 5 shows a dissolution profile of Ibuprofen drug (as a % of the total drug released over 24 hours) present in the modified release formulation of Example 9 prepared by using 10 wt. % of HPC of Example 2, and its comparison with a dissolution profile of Ibuprofen drug present in the Comparative modified release formulation of Example 9A prepared by using 10 wt. % of HPC of Comparative Example 5.

FIG. 6 shows a dissolution profile of Ibuprofen drug (as a % of the total drug released over 24 hours) present in the modified release formulation of Example 10 prepared by using 25 wt. % of HPC of Example 2, and its comparison with a dissolution profile of Ibuprofen drug present in the Comparative modified release formulation of Example 10A prepared by using 25 wt. % of HPC of Comparative Example 5.

FIG. 7 shows a dissolution profile of Hydrochlorothiazide (HCTZ) drug (as a % of the total drug released over 24 hours) present in the modified release formulation of Example 11 prepared by using 15 wt. % of HPC of Example 3, and its comparison with a dissolution profile of the Comparative modified release formulation of Example 11A prepared by using 15 wt. % of HPC of Comparative Example 5.

FIG. 8 shows a dissolution profile of Hydrochlorothiazide (HCTZ) drug (as a % of the total drug released over 24 hours) present in the modified release formulation of Example 12 prepared by using 15 wt. % of HPC of Example 4, and its comparison with the dissolution profile of the Comparative modified release formulation of Example 11A.

### DETAILED DESCRIPTION OF THE INVENTION

Before explaining at least one embodiment of the inventive concept(s) in detail by way of exemplary drawings, experimentation, results, and laboratory procedures, it is to be understood that the inventive concept(s) is not limited in its application to the details of construction and the arrangement of the components set forth in the following description or illustrated in the drawings, experimentation and/or results. The inventive concept(s) is/are capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific and technical terms used in connection with the present disclosure shall have the meanings that are commonly understood by those of ordinary skill in the art. Further, unless otherwise required by context, singular terms shall include pluralities and plural terms shall include the singular. Generally, nomenclatures utilized in connection with, and techniques of chemistry described herein are those well-known and commonly used in the art. Reactions and purification techniques are performed according to manufacturer's specifications or as commonly accomplished in the art or as described herein. The nomenclatures utilized in connection with, and the laboratory procedures and techniques of, analytical chemistry, synthetic organic chemistry, and medicinal and pharmaceutical chemistry described herein are those well-known and commonly used in the art. Standard techniques are used for chemical syntheses, chemical analysis, pharmaceutical preparation, formulation, and delivery, and treatment of patients.

All patents, published patent applications, and non-patent publications mentioned in the specification are indicative of the level of skill of those skilled in the art to which this present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, and/or the variation that exists among the study subjects. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein, the term “drug” or “active pharmaceutical ingredient(s)” or “API(s)” means any substance or mixture of substances intended to be used in the manufacture of a drug (medicinal) product and that, when used in the production of a drug product, becomes an active ingredient of the drug product. Such substances are intended to furnish pharmacological activity or other direct effect in the diagnosis, cure, mitigation, treatment, or prevention of disease or to affect the structure or function of the body of humans or other animals. Further, the terms “drug” or “active pharmaceutical ingredient(s)” or “API(s)” can be used interchangeably in the present disclosure.

As used herein, the term “modified release” in relation to the composition of the present disclosure means a composition which is not intended for immediate release and can encompasses controlled release, sustained release, prolonged release, timed release, retarded release, extended release and delayed release.

As used herein, the term “modified release pharmaceutical formulation” or “modified release dosage forms” can be described as dosage forms whose drug-release characteristics of time course and/or location are chosen to accomplish therapeutic or convenience objectives not offered by conventional dosage forms such as a solution or an immediate release dosage form. Modified release solid oral dosage forms include both delayed and extended release drug products (as per USFDA guideline for ‘SUPAC-MR: Modified Release Solid Oral Dosage Forms’).

As used herein, the term “Pharmaceutical Effective Amount” can describe a non-toxic and sufficient amount of the drugs that may be needed for treatment or prevention of disease, and may be adjusted depending on a variety of factors, including, but not limiting to, disease type, disease severity, the type and content of active ingredients or other ingredients contained in the formulation, dosage form, patient's age, weight, health condition, gender and eating behavior, drug administration time, and the like. An appropriate effective amount in any individual case may be determined by one of ordinary skilled in the art using only routine experiments.

One aspect of the present disclosure provides a hydroxypropyl cellulose (HPC) having a molar substitution number per mole of anhydrous glucose (MS) varying in the range of from about 3.0 to about 3.9 and a weight average molecular weight of from about 700,000 to about 2,000,000 Daltons. In one non-limiting embodiment of the present disclosure, the molar substitution of hydroxypropyl cellulose can vary in the range of from about 3.2 to about 3.8. In another non-limiting embodiment of the present disclosure, the molar substitution of hydroxypropyl cellulose can vary in the range of from about 3.4 to about 3.7.

In one non-limiting embodiment of the present disclosure, the weight average molecular weight of hydroxypropyl cellulose can vary in the range of from about 750,000 to about 2,000,000 Daltons or from about 800,000 to about 2,000,000 Daltons or from about 800,000 to about 1,700,000 Daltons or from about 1,000,000 to about 1,500,000 Daltons.

The hydroxypropyl cellulose according to the present disclosure can be present in powder form and can have particles having volume average particle size of less than 100 μm. In one non-limiting embodiment of the present disclosure, the volume average particle size of hydroxypropyl cellulose can vary in the range of from about 40 μm to about 80 μm or from about 50 μm to about 75 μm. The volume average particle size of hydroxypropyl cellulose of the present disclosure refers to a particle size D50 at the point where the cumulative volume reaches 50% in a particle size distribution obtained by performing measurements using a laser scattering particle size distribution measurement device called Malvern Mastersizer 3000.

The hydroxypropyl cellulose (HPC) according to the present disclosure can be prepared by methods known in the related art(s) for preparing hydroxyalkyl celluloses. In one non-limiting embodiment of the present disclosure, the hydroxypropyl cellulose (HPC) can be obtained by (i) reacting a raw cellulose material with an aqueous alkali solution to obtain an alkali cellulose; (ii) further reacting the alkali cellulose with propylene oxide to obtain a crude hydroxypropyl cellulose product; (iii) neutralizing the excess of alkaline solution with an aqueous acidic solution; and (iv) washing, filtering and drying the crude product to obtain a final purified hydroxypropyl cellulose product. The purified hydroxypropyl cellulose product can be ground further to obtain hydroxypropyl cellulose in powder form. 1 wt. % aqueous solution of the hydroxypropyl cellulose obtained in accordance with the present disclosure can have a viscosity of at least 300 mPa·s at 25° C. In one non-limiting embodiment of the present disclosure, the viscosity of hydroxypropyl cellulose can vary in the range of from about 300 to about 10,000 mPa·s or from about 500 to about 8,000 mPa·s or from about 1,000 to about 5,000 mPa·s or from about 1500 to about 3,000 mPa·s.

Another aspect of the present disclosure provides a modified release formulation or a modified release dosage form comprising hydroxypropyl cellulose (HPC) having a molar substitution number per mole of anhydrous glucose (MS) varying in the range of from about 3.0 to about 3.9 and a weight average molecular weight of from about 700,000 to about 2,000,000 Daltons. In one non-limiting embodiment of the present disclosure, the molar substitution of hydroxypropyl cellulose can vary in the range of from about 3.2 to about 3.8. In another non-limiting embodiment of the present disclosure, the molar substitution of hydroxypropyl cellulose can vary in the range of from about 3.4 to about 3.7.

In one non-limiting embodiment of the present disclosure, the weight average molecular weight of the hydroxypropyl cellulose (HPC) can vary in the range of from about 750,000 to about 2,000,000 Daltons. In another non-limiting embodiment of the present disclosure, the weight average molecular weight of hydroxypropyl cellulose can vary in the range of from about 800,000 to about 2,000,000 Daltons or from about 800,000 to about 1,700,000 Daltons or from about 1,000,000 to about 1,500,000 Daltons.

In one non-limiting embodiment of the present disclosure, the hydroxypropyl cellulose (HPC) can be present in powder form and can have particles having a volume average particle size of less than 100 μm. In one non-limiting embodiment of the present disclosure, the volume average particle size of HPC can vary in the range of from about 40 to about 80 μm or from about 50 to 75 μm. The volume average particle size of hydroxypropyl cellulose of the present disclosure refers to a median particle size (D50) at the point where the cumulative volume reaches 50% in a particle size distribution obtained by performing measurements using a laser scattering particle size distribution measurement device called Malvern Mastersizer 3000.

Further, the hydroxypropyl cellulose (HPC) according to the present disclosure can be used in an amount sufficient to modify the release of at least one active pharmaceutical ingredient (API) present in the modified release formulation of the present disclosure. In one non-limiting embodiment of the present disclosure, the amount of hydroxypropyl cellulose can vary in the range of from about 5 wt. % to about 99 wt. %, or from about 10 wt. % to about 90 wt. %, or from about 15 wt. % to about 75 wt. %, or from about 30 wt. % to about 60 wt. %, of the total modified release formulation.

The modified release formulation of the present disclosure can further comprise at least one active pharmaceutical ingredient (API). In one non-limiting embodiment of the present disclosure, the active pharmaceutical ingredient can be a drug. Alternatively, the active pharmaceutical ingredient (API) can be a bio-functional ingredient. Examples of bio-functional ingredients useful for the purpose of the present disclosure can include, but are not limited to, dietary supplements including, but not limiting to, vitamins, such as, vitamin C, vitamin B 1, B2, B3, B6, and B12; minerals, such as, zinc, magnesium, iron, and melatonin; herbal dietary supplements, such as, curcumin, ashwagandha, and fenugreek extract; amino acids, such as, isoleucine, glycine, L-tryptophan, glucosamine, chondroitin and the like. Any drugs having a wide range of water solubilities can suitably be used in the modified release formulation of the present disclosure. In one non-limiting embodiment of the present disclosure, the drug can be selected from the group of drugs having a water solubility at 25° C. greater than 1 mg/L, or greater than 16 mg/L, or greater than 20 mg/L, or greater than 700 mg/L, or greater than 18,000 mg/L, or greater than 300,000 mg/L. Further, the drug suitable for use in the modified release formulation of the present disclosure can be selected from those belonging to different therapeutic classes such as antipyretic, analgesic and anti-inflammatory drugs, anthelmintic drugs, cardiovascular drugs, antibacterial drugs, bronchodilating drugs, anti-asthmatic drugs, gastrointestinal drugs, antidiabetic drugs, antiprotozoal drugs, antiviral drugs, anti-epileptic drugs, anti-diuretic drugs, or its pharmaceutically acceptable salts and esters thereof.

Examples of the antipyretic, analgesic and anti-inflammatory drugs can include, but are not limited to, etodolac, ibuprofen, diclofenac and tofacitinib. Examples of the anthelminthic drugs can include, but are not limited to, albendazole. Examples of the cardiovascular drugs can include, but are not limited to, carvedilol, metoprolol, sacubitril and valsartan. Examples of antibacterial drugs can include, but are not limited to, erythromycin, ciprofloxacin or any pharmaceutically acceptable salt or ester. Examples of bronchodilating drugs can include, but are not limited to, salbutamol. Examples of anti-asthmatic drugs can include, but are not limited to, doxofylline and theophylline. Examples of gastrointestinal drugs can include, but are not limited to, cimetidine, and omeprazole. Examples of antidiabetic drugs can include, but are not limited to, metformin hydrochloride and sitagliptin. Examples of antiprotozoal drugs can include, but are not limited to, tinidazole. Examples of antiviral drugs can include, but are not limited to, acyclovir. Examples of anti-epileptic drugs can include, but are not limited to, carbamazepine. Examples of anti-diuretic drugs can include, but are not limited to, chlorothiazide and hydrochlorothiazide.

Further, the active pharmaceutical ingredient can be present in a pharmaceutical effective amount in the modified release formulation of the present disclosure. As stated above, the modified release formulation of the present disclosure can be suitable for any drugs having a wide range of water solubility. Therefore, the amount of drug or drugs present in the modified release formulation of the present disclosure can be varied depending upon various factors including, but not limiting to, type of drug or drugs being used, nature and severity of the ailment being treated/cured, the type and content of active ingredients or other ingredients contained in the formulation, dosage form, patient's age, weight, health condition, gender and eating behavior, drug administration time, and the like.

The modified release formulation of the present disclosure can further comprise at least one pharmaceutical acceptable excipient. The pharmaceutical acceptable excipients which are commonly used in the pharmaceutical compositions are also suitable for use in the present modified release formulation, for example, excipients as described in Handbook of Pharmaceutical Excipients, Rows et al., Eds., 4^{th} Edition, Pharmaceutical Press (2003) or Remington: The Science and Practice of Pharmacy, (formerly called Remington's Pharmaceutical Sciences), Alfonso R. Gennaro, ed., Lippincott Williams & Wilkins; 20th edition (Dec. 15, 2000). Examples of such excipients can include, but are not limited to, fillers, pigments, binders, lubricants, flow aids, flavors, sweeteners, preservatives, stabilizers, antioxidants, and the like.

The pharmaceutical acceptable excipient can be present in amount without affecting the therapeutic properties of the present modified release formulation. The pharmaceutically acceptable excipient can comprise in the range of from about 1 wt. % to about 85 wt. %, of the total modified release formulation. In one non-liming embodiment of the present disclosure, the pharmaceutically acceptable excipient can comprise from about 5 wt. % to about 75 wt. % of the total modified release formulation, or from about 5 wt. % to about 60 wt. % of the total modified release formulation.

Examples of fillers that can be present in the modified release formulation of the present disclosure can include, but are not limited to, cellulose; oligosaccharides, such as, lactose and sucrose; sugars; starches; processed starches; sugar alcohols, such as, mannitol, sorbitol, xylitol and lactitol; silicic acid; inorganic acid salts; calcium sulfate, and aluminum and magnesium silicate complexes and oxides. Specific examples of the inorganic acid salt excipients can include, but are not limited to, phosphoric salts such as calcium diphosphate dihydrate and hydrosulfates. Further, the fillers can be present in an amount of from about 5.0 wt. % to about 15 wt. % of the total modified release formulation.

Examples of binders that can be present in the modified release formulation of the present disclosure can include, but are not limited to, polyvinyl pyrrolidone (PVP), sucrose, lactose, starches, processed starches, sugars, gum arabic, tragacanth gum, guar gum, pectin, wax-based binders, microcrystalline cellulose (MCC), methylcellulose, carboxymethylcellulose, copovidone, gelatin and sodium alginate. The binders can be present in an amount of from about 1 wt. % to about 80 wt. % of the total modified release formulation.

Similarly, suitable lubricants that can be present in the modified release formulation of the present disclosure can include, but are not limited to, magnesium stearate, stearic acid, palmitic acid, calcium stearate, talc, carnauba wax, hydrogenated vegetable oils, mineral oils, polyethylene glycol, sodium stearyl fumarate and sucrose fatty acid esters of acids such as stearic acid, palmitic acid, myristic acid, oleic acid, lauric acid, behenic acid, erucic acid and the like. Further, the lubricants can be present in an amount of from about 0.1 wt. % to about 20 wt. % of the total modified release formulation.

The modified release formulation of the present disclosure can further comprise at least one additional modifying release agent. Examples of such modifying release agent can include, but are not limited to, sodium alginate, carboxy vinyl polymers, acrylic acid-based polymers such as aminoalkyl methacrylate copolymer RS (Eudragit RS, manufactured by Rohm Pharma GmbH) and ethyl acrylate-methyl methacrylate copolymer suspension (Eudragit NE, manufactured by Rohm Pharma GmbH). The additional modifying release agent can be present in an amount of from about 5 wt. % to about 50 wt. %, of the total modified release formulation.

Examples of pH regulators suitable for use in the modified release formulation of the present disclosure can be inorganic acids, such as hydrochloric acid, sulfuric acid, hydrobromic acid and phosphoric acid; organic acids, such as acetic acid, succinic acid, fumaric acid, malic acid, oxalic acid, lactic acid, glutaric acid, salicylic acid and tartaric acid, and salts thereof; or any combinations thereof.

Other pharmaceutically acceptable excipients can also be present in the modified release formulation of the present disclosure. For example, colorants or food dyes such as food yellow No. 5, food red No. 2 and food blue No. 2, food lake dyes, or iron sesquioxide; pH buffers, such as amine-based buffers or carbonate-based buffers; surfactants, such as sodium lauryl sulfate, polysorbate 80, hydrogenated oil, or polyoxyethylene (160) polyoxypropylene (30) glycol; stabilizers, such as tocopherol, tetrasodium edetate, nicotinamide or cyclodextrins; and acidifiers, such as citric acid, tartaric acid, malic acid or ascorbic acid.

The modified release formulation of the present disclosure can be present in a dry solid dosage form. The dry solid dosage forms are particularly useful for delivering an accurate dosage to a specific site, usually orally, but can also be administered via other routes that are known to a person skilled in the pertinent art, such as sublingual/buccal, rectal, vaginal and ocular. In one non-limiting embodiment of the present disclosure, the modified release formulation can be present in a solid dosage form suitable for oral administration. Such dosage forms can include, but are not limited to, tablets, capsules, powder, granules, sachets or lozenges. In one non-limiting embodiment of the present disclosure, the modified release formulation is tablets.

Further, the tablet form of the modified release formulation of the present disclosure, can be coated with base materials for the purpose of masking a smell or taste, stabilizing, maintaining efficacy and the like. The coating can comprise sugars or film forming polymers.

In one non-limiting embodiment of the present disclosure, the tablets can be sugar coated, film coated, enteric coated or coated with a thin layer or a film of modifying release agents to further modify the release of the drugs/active pharmaceutical ingredients from the formulation.

In one non-limiting embodiment of the present disclosure, the tablets can be sugar coated. The sugar coatings of tablets is/are basically a thick and hard coatings of sugars surroundings the surface of the tablets which is desirable to hide the flavor of a particular unpleasant tasting drugs or any other active pharmaceutical ingredients, and also to provide stability to tablets from breaking under the effect of light and moisture. The sugar coating of the tablets according to the present disclosure can be carried out using a sugar base material. Examples of the sugar base material useful for the purpose of the present disclosure can include, but are not limited to, white soft sugar. Additional pharmaceutically acceptable excipient(s) can also be added in the sugar base materials to enhance the properties of the sugar base coating such as improved binding ability and mechanical strength, and anti-sticking property. Examples of such additional excipients can include, but are not limited to, gelatin, gum arabic, polyvinylpyrrolidone, pullulan, talc, precipitated calcium carbonate, calcium phosphate, calcium and the like. Additionally, the sugar-base coating can also comprise flavorants or colorants/pigments as additional pharmaceutical excipients.

In another non-limiting embodiment of the present disclosure, the tablets can be film coated. The film coating of tablets in general includes enveloping of tablet's core with a thin film of protective polymers. Accordingly, the tablet of the present disclosure can comprise thin film of polymers, particularly water-soluble film-based polymers as a coating layer. Both synthetic as well as natural polymers can be used for tablet film coating. Examples of synthetic polymer can include, but are not limited to, polyvinyl alcohol, polyvinyl alcohol-polyethylene glycol graft copolymers, polyvinyl alcohol-acrylic acid-methyl methacrylate copolymers, polyvinyl acetal diethylamino acetate, aminoalkyl methacrylate copolymers, polyvinylpyrrolidone and macrogol. Examples of natural polymers can include, but are not limited to, polysaccharides such as pullulan.

In another non-limiting embodiment of the present disclosure, the tablets can be enteric film coated. The enteric film coating on tablets is desirable to protect the stomach from the tablet formulation; protect the drugs against stomach acids, and to release the active pharmaceutical ingredients in specific locations which is usually lower area of stomach or intestines. The enteric film coating of the present tablets can be carried out using enteric film coating base materials. Examples of such materials can include, but are not limited to, acrylic acid derivatives such as methacrylic acid copolymer L, methacrylic acid copolymer LD and methacrylic acid copolymer S; and natural materials such as shellac.

Further, the tablet form of the modified release formulation of the present disclosure can be coated with a thin layer or a film of a modifying release agent to further enhance or improve the modifying release efficiency of the present modified release formulation. For this purpose, tablets of the present disclosure can be coated with a thin layer or film of the present modified release formulation, or a thin layer or film of an additional modifying release agent, or combination of both.

In one non-limiting embodiment, the tablets can be coated with a thin layer or a film of the modified release formulation of the present disclosure. The modified release formulation used for coating purpose can further comprises at least one of the coating materials used for sugar coating, film coating, and enteric coating, as hereinabove described in the present disclosure.

In another non-limiting embodiment of the present disclosure, the tablets can be coated with a thin layer or film of an additional modified release agent. Examples of such additional modified release agent can include, but are not limited to, Hypromellose, polyethylene oxide, hydroxyethyl cellulose, ethyl cellulose, methacrylic acid copolymers, guar, xanthan, alginates, starch derivatives, waxes and fats.

The coating materials used for the purpose of the present disclosure can further comprise at least one of the pharmaceutically acceptable excipients described herein above in the present disclosure, such as binders, lubricants, plasticizers, stabilizers, colorants and the like.

There is no limitation regarding the method employed for preparing the modified release formulation of the present disclosure, particularly the modified release formulation in the solid oral dosage form such as tablets. Any tableting methods which are well known in the pharmaceutical art such as wet granule tableting method or a dry granule tableting method or a dry direct tableting method can suitably be used for the purpose of the present disclosure. In one non-limiting embodiment, the modified release formulation in tablets form can be prepared by a wet granulation method wherein the method comprising the steps of (i) blending a mixture of hydroxypropyl cellulose, the active pharmaceutical ingredients such as drug(s) and other required pharmaceutical acceptable excipients to make a uniform homogenous blend; (ii) adding a wetting agent to obtain a kneaded blend followed by granulating the same to obtain resultant granules; (iii) drying and sizing the resultant granules to an optimum size suitable for compression; (iv) blending the sized granules obtained from process step (iii) with a suitable pharmaceutical acceptable lubricant such as magnesium stearate; and finally (v) compressing the blended granules obtained from the process step (iv) into tablets.

In another non-limiting embodiment, the modified release formulation of the present disclosure can be prepared by a dry granulation method comprising the steps of: (i) dispensing and mixing pre-determined amounts of various ingredients of the modified release formulation of the present disclosure such as hydroxypropyl cellulose, the active pharmaceutical ingredients and the pharmaceutical acceptable excipients to obtain a uniform powder blend; (ii) subjecting the uniform powder blend to compression either by slugging or roller compaction to obtain flat large tablets or pellets; (iii) milling and sieving the flat large tablets or pellets to obtain uniform granules; and (iv) subjecting the granules to tablet compression. Lubricants such as magnesium stearate and other excipients such as disintegrants, glidants and the like can also be added in the uniform granules before subject the same to tablet compression.

In another non-limiting embodiment, the modified release formulation of the present disclosure can be prepared by a dry direct tableting method or a directly compressible method comprising the steps of (i) pre-milling or sieving various ingredients of the modified release formulation of the present disclosure such as hydroxypropyl cellulose, the active pharmaceutical ingredients such as drug(s) and the pharmaceutical acceptable excipients including lubricant to obtain powdered ingredients; (ii) uniformly blending or mixing the powdered ingredients to obtain a homogenous blend; and (iii) subjecting the homogenous blend to tablet compression to obtain tablets.

In one non-limiting embodiment of the present disclosure, the hydroxypropyl cellulose present in the modified release formulation: (i) can provide low dose dumping of the active pharmaceutical ingredient(s), (ii) can uniformly release the active pharmaceutical ingredient(s) over a period of time, (iii) can provide effective tablet compaction properties, and (iv) can provide controlled release of the active pharmaceutical ingredient at a lower polymer usage levels.

The following examples illustrate the present disclosure, parts and percentages being by weight, unless otherwise indicated. Each example is provided by way of explanation of the present disclosure, not limitation of the present disclosure. In fact, it will be apparent to those skilled in the art that various modifications and variations can be made in the present disclosure without departing from the scope or spirit of the invention. For instance, features illustrated or described as part of one embodiment, can be used on another embodiment to yield a still further embodiment. Thus, it is intended that the present disclosure covers such modifications and variations as come within the scope of the appended claims and their equivalents.

### EXAMPLES

Examples 1-4 of the present disclosure provides hydroxypropyl celluloses (HPC) of the present disclosure.

### Example 1 (Ex. 1)

### Preparation of Hydroxypropyl Cellulose (HPC) with HP-MS of 3.72

1 part of cut, purified cellulose was immersed in a mixture of 7 parts of heptane, 2 parts of tertiary butanol, 0.5 parts of water and 0.2 parts of 50% aqueous sodium hydroxide solution to obtain a slurry. The slurry was stirred to obtain an alkali cellulose. 2.6 parts of propylene oxide (PO) was then added to the slurry containing the alkali cellulose to obtain a reaction mixture. The obtained reaction mixture was then heated to 105° C. and held there until all the PO is reacted. The reaction mixture containing the crude hydroxypropyl cellulose product was then cooled to room temperature and excess of sodium hydroxide was neutralized with acetic acid. The solvent was removed by filtration, and the product was then washed with hot water and filtered to remove salts and impurities. The purified cake thus obtained was dried at about 130-140° C. until <5% moisture was reached. The dried hydroxypropyl cellulose thus obtained was ground until hydroxypropyl cellulose in powder form having particles of D₅₀<100 μm was obtained. The hydroxypropyl molar substitution was analyzed as 3.7. The Mw was 1,510,000 Daltons, and the aqueous solution viscosity was 1,800 mPa·s at 1 wt. % in water. The volume-average particle size (D50) was 52 μm.

### Example 2 (Ex. 2)

### Preparation of HPC with HP-MS 3.72

HPC of this example was prepared in the same manner as described for Example 1 except that 2.8 parts of propylene oxide was used.

### Example 3 (Ex. 3)

### Preparation of HPC with HP-MS 3.56

HPC of this example was prepared using the procedure described in Example 1 except that 2.0 parts of propylene oxide was used.

### Example 4 (Ex. 4)

### Preparation of HPC with HP-MS: 3.56

HPC of this example was prepared in the same manner as described for Example 1 except that 2.1 parts of propylene oxide was used.

### Comparative Example 5 (Comp. Ex. 5)

A commercial HPC, Klucel HXF as marketed by Ashland Specialty Ingredient G.P., was used as a comparative example to illustrate the benefits of HPCs of Examples 1-4 of the present disclosure.

The hydroxypropyl cellulose of Examples 1-4 and Comparative Example 5 were measured for hydroxypropyl molar substitution (HP-MS), molecular weight (MW) distribution, viscosity, and a volume average particle size as per the testing methods given below. The measured values are given in Table 1.

TABLE 1
Characteristic Details of HPCs of Examples
1-4 and Comparative Example 5

| | | | | Particle Size |
|---|---|---|---|---|
| | | | Viscosity (mPa · s | (μm) (Volume- |
| | HP- | Mol. wt. | of 1 wt. % aqueous | average particle |
| HPC | MS | (Dalton) | solution at 25° C.) | size (D50) |
| Ex. 1 | 3.72 | 1,510,000 | 1,800 | 52 |
| Ex. 2 | 3.72 | 1,450,000 | — | 74 |
| Ex. 3 | 3.56 | — | 1,490 | 61 |
| Ex. 4 | 3.56 | — | 1,080 | 58 |
| Comp. Ex. 5 | 4.20 | 1,480,000 | 1,600 | 64 |

### Testing Methods:

### 1. Hydroxypropyl Molar Substitution Measurement:

HP-MS value of the HPCs of Examples 1-4 and Comparative Example 5 was determined by NMR as follows:

Sample hydrolysis: 25 mg of sample was initially swelled in 1.00 gm of D₂O for 30 mins. To the swelled sample, 0.5 gm of 35% DCl was added. The solution vial was maintained at 70° C. for 1 hour in a heat block. The sample solution was cool down for ˜30 minutes and transferred to 5 mm NMR tube for analysis.

### NMR Measurement: Quantitative

1H NMR spectrum was recorded using Bruker 400 MHz NMR spectrometer and processed with Topspin software. Acquisition parameters were as follows: temperature 300K, sweep width 20 ppm, pulse width 45 deg, number of scans 32, relaxation delay 30 s. Processing parameters were as follows: line broadening 0.3 Hz.

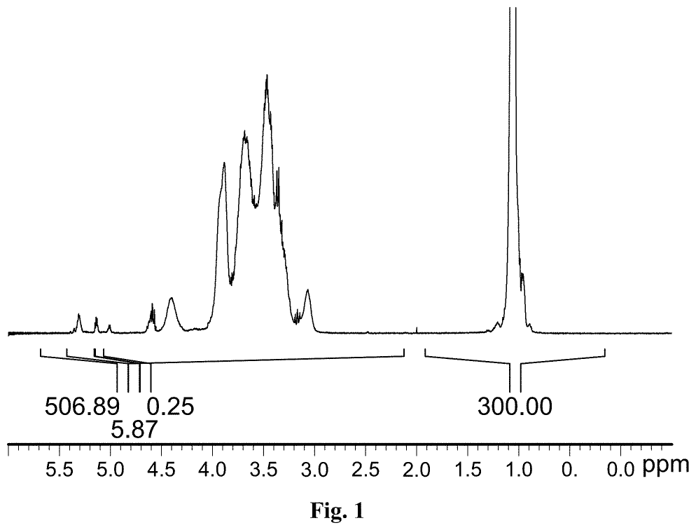

Spectrum was phase and baseline corrected using standard practice. Center of the most up-field signal (methyl of hydroxypropyl substitution) was referenced to 1.05 ppm. The spectrum was integrated as follows:
Region A (IA)=1.90-0.15 ppm (integral area was calibrated to a value of 300, other integral areas were relative to this integral value).
Region B (IB)=5.70-2.15 ppm.
NMR spectrum of a representative HPC sample is shown in FIG. 1.
   HP MS and wt. % HP were Calculated as Follows:

HP MS=(7/(IB−IA))*100

Wt. % HP=((HP MS*MW OC3H6OH)/(MW AHG+(HP MS*(MW C3H6OH−MW H))))*100

MW OC3H6OH=75.086

MW C3H6OH=59.087

MW AHG=162.141

MW H=1.008

### 2. Molecular Weight (MW) Distribution:

Analysis of molecular weight (MW) distribution of hydroxypropyl celluloses of the present Examples 1-4 and Comparative Example 5 was determined by using size exclusion chromatography. Molecular weight is the sum of the atomic weights of the atoms in a molecule. As used herein with respect to polymers, the terms molecular weight, average molecular weight, mean molecular weight, and apparent molecular weight refers to the arithmetic mean of the molecular weight of individual macromolecules as measured by size-exclusion chromatography (SEC). The relative molecular weight averages from the analytical SEC were calculated versus poly (ethylene glycol/ethylene oxide) (PEG/PEO) standards with narrow molecular weight distribution. Size exclusion chromatography was performed according to the following method:

### (a). Chromatography Set-Up

All Waters modules in the set-up are manufactured by Waters Corporation, 34 Maple Street, Milford, Mass. 01757, USA. The set-up may be replaced with similar from different manufacturer(s).
Waters M515 solvent delivery system
Waters M717 auto sampler
Waters M2414 differential refractive index detector (DRI) for the relative SEC*
Column bank(s)—see the details in the “Analysis conditions” section below
Waters Empower 2 software
* RI range 1.00 to 1.75 RIU
Measurement range 7×10−7 RIU
Drift—2×10−7 RIU

### (b) Analysis Conditions for SEC

Mobile Phase—55% 0.1 M Lithium Acetate/45% Ethanol
Flow Rate—0.8 ml/min
Columns—TSKgel guard (6 mm×40 mm)+2 Linear TSK GMPWXL columns; 13 μm; 300 mm×7.8 mm (TOSOH Bioscience LLC, 3604 Horizon Drive, Suite 100, King of Prussia, Pa. 19406, USA
Column Temperature—35° C.
DRI (differential refractive index) Detector Temperature—35° C.
Calibration—PEO/PEG standards with narrow molecular weight distribution (PSS-USA, Inc. Amherst Fields Research Park, 160 Old Farm Road, Amherst, Mass. 01002)
Sample Concentration—Typically 1 mg/ml (unless otherwise noted)
Injection volume—200 μl

### 3. Viscosity Measurement:

Slowly added the HPC into the stirring deionized water and stirred for one hour. Equilibrate the temperature in a 25° C. temperature bath for one hour. Measure viscosity via Brookfield viscometer using LV spindle #4 at 30 rpm, taking reading after 3 minutes.

### 4. Particle Size Measurement:

The particle size of the powder form of hydroxypropyl celluloses of Examples 1-4 and Comparative Example 5 was measured by using the Malvern Mastersizer 3000 laser diffraction particle size analyzer. The measurements were done on samples in powder form using the Aero S dry powder feeder equipped with a general-purpose hopper/sample tray pair and a standard stainless-steel venturi powder dispenser. The Aero S hopper gap was set to 4.0 mm. Powder sample was measured by completely filling a ¼ teaspoon measuring spoon and loaded into the hopper. The powder feed rate was set to 30%, and the air pressure was set to 3.0 bar. The obscuration limits were set to 0.2% low limit and 10% high limit with obscuration filtering turned off. The background measurement time was set to 10 seconds and the sample measurement time was set to 20 seconds, with the measurement set to start once the obscuration was within the set range and after a stabilization time of 0.1 seconds. The Fraunhofer scattering model and the “General Purpose” analysis model were used for data analysis, which were converted to particle diameter using the volume distribution

A commercially available HPC marketed as Nisso HPC H having a molecular weight of 652,000, a 1 wt. % aqueous solution viscosity of 146 mPa·s at 25° C., and a particle size D50 of 170 μm is expected to exhibit poorer modified drug release performance than the HPC of the present disclosure. Molecular weight, viscosity and particle size of the Nisso HPC H were measured as per the testing methods described hereinabove.

### Drug Modified Release Testing

The hydroxypropyl celluloses of the present Examples 1-4 are used further in the modified release formulations along with drug(s) and other pharmaceutical acceptable excipients. Table 2 lists drugs used for producing the present modified release formulations.

TABLE 2
List of drugs tested for the present modified release formulations

| Drug | Solubility in Water at 25° C. (mg/L) |
|---|---|
| Hydrochlorothiazide (HCTZ) | 722 |
| Ibuprofen | 21 |

### Example 6

### Modified Release Formulation (Ex. 6) having 30 wt. % HPC of Example 1

Hydrochlorothiazide, HPC of Example 1, and spray dried lactose (Ingredient 1-3) were weighed in weight proportion listed in Table 3, screened through a USP sieve #20, and blended in a Turbula mixer for 10 minutes. Sodium stearyl fumarate, colloidal silicon dioxide and magnesium stearate were also weighed separately, screened through a USP sieve #20 and added into the blend of Ingredients 1-3. This resulting powder blend thus obtained was again blended for 2 minutes in a Turbula mixer to obtain a homogenous powder blend. The homogenous powder blend was then compressed into tablets using a compaction simulator STYL'one, simulating manesty beta press operating at a press speed of 67 RPM (64320 tablets/hour), using 11.28 flat faced punches and die at a compaction force of 25 kN. Tablets with individual tablet weight of approximate 500 mg were obtained.

TABLE 3
Modified release formulations of Examples 6 and 6A

| | | Ex. 6 | | Ex. 6A | |
|---|---|---|---|---|---|
| | | Amount of Ingredients | | Amount of Ingredients | |
| | | % w/w (based | (mg) based on | % w/w (based | (mg) based on |
| | | on 100 wt. % | individual | on 100 wt. % | individual |
| S. | | of a dry tablet | tablet weight | of a dry tablet | tablet weight |
| No. | Ingredients | composition) | of 500 mg | composition) | of 500 mg |
| 1 | Hydrochlorothiazide | 10.0 | 50.0 | 10.0 | 50.0 |
| 2 | HPC of Ex. 1 | 30.0 | 150.0 | Nil | Nil |
| | HPC of Comp. Ex. 5 | Nil | Nil | 30.0 | 150.0 |
| 3 | Spray dried lactose | 58.5 | 292.5 | 58.5 | 292.5 |
| 4 | Sodium Stearyl Fumarate | 0.5 | 2.5 | 0.5 | 2.5 |
| 5 | Colloidal Silicon Dioxide | 0.5 | 2.5 | 0.5 | 2.5 |
| 6 | Magnesium Stearate | 0.5 | 2.5 | 0.5 | 2.5 |
| | Total | 100 | 500 | 100 | 500 |

### Example 6A

### Comparative Modified Release Formulation (Ex. 6A) having 30 wt. % HPC of Comparative Example 5

A comparative modified release formulation (Ex. 6A) using 30.0 wt. % HPC of Comparative Example 5 was prepared in the same manner as described above in Example 6 using the ingredients in amounts listed in Table 3 above.

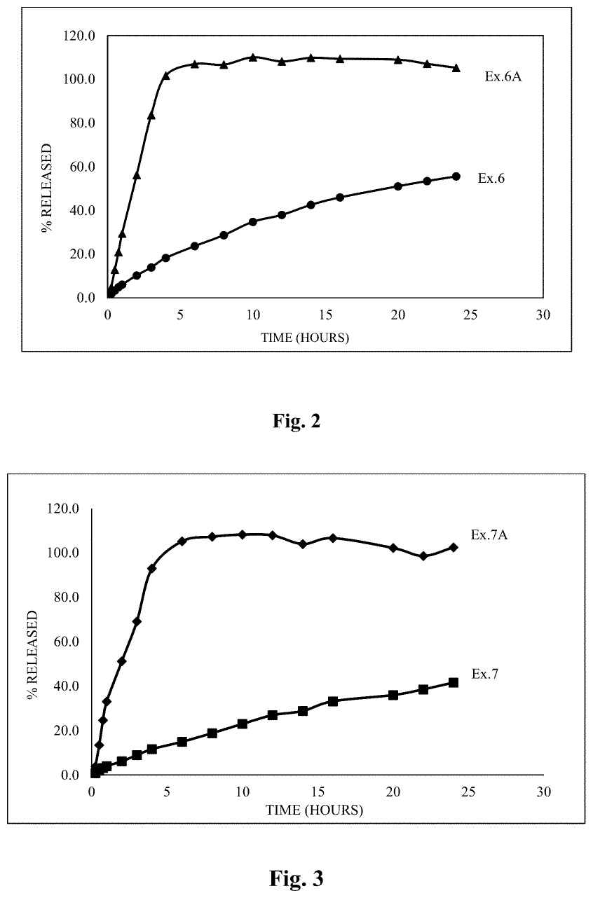

Dissolution testing of the tablets of Examples 6 and 6A was performed at the dose of 50 mg using USP Apparatus I in 0.05 M phosphate at pH=6.8 and at a constant stirring speed of 100 RPM. Samples were taken at 0.25, 0.5, 0.75, 1, 2, 3, 4, 6, 8, 10, 12, 14, 16, 20, 22, 24 hours and filtered through a 0.45 μm nylon membrane. The samples were analyzed by inline UV detection at 272 nm. FIG. 2 shows the dissolution profile of Hydrochlorothiazide (HCTZ) as a % of the total drug released over 24 hours for both the formulations i.e. Ex. 6 and Ex. 6A. It is evident from FIG. 2 that the drug release from the modified release formulation of Example 6 was slower than the drug release from the comparative modified release formulation of Example 6A.

### Example 7

### Modified Release Formulation (Ex. 7) having 60 wt. % HPC of Example 1

A modified release formulation (Ex. 7) comprising 60 wt. % HPC of Example 1 was prepared in this example. The modified release formulation of this example was prepared in the same manner as described above in Example 6 using the ingredient in amounts listed in Table 4 below.

TABLE 4
Modified release formulations of Examples 7 and 7A

| | | Ex. 7 | | Ex. 7A | |
|---|---|---|---|---|---|
| | | Amount of Ingredients | | Amount of Ingredients | |
| | | % w/w (based | (mg) based on | % w/w (based | (mg) based on |
| | | on 100 wt. % | individual | on 100 wt. % | individual |
| S. | | of a dry tablet | tablet weight | of a dry tablet | tablet weight |
| No. | Ingredients | composition) | of 500 mg | composition) | of 500 mg |
| 1 | Hydrochlorothiazide | 10.0 | 50.0 | 10.0 | 50.0 |
| 2 | HPC of Ex. 1 | 60.0 | 300.0 | Nil | nil |
| | HPC of Comp Ex. 5 | Nil | Nil | 60.0 | 300.0 |
| 3 | Spray Dried Lactose | 28.5 | 142.5 | 28.5 | 142.5 |
| 4 | Sodium Stearyl Fumarate | 0.5 | 2.5 | 0.5 | 2.5 |
| 5 | Colloidal silicon dioxide | 0.5 | 2.5 | 0.5 | 2.5 |
| 6 | Magnesium Stearate | 0.5 | 2.5 | 0.5 | 2.5 |
| | Total | 100 | 500 | 100 | 500 |

### Example 7A

### Comparative Modified Release Formulation (Ex. 7A) having 60 wt. % HPC of Comparative Example 5

A control modified release formulation (Ex. 7A) comprising 60.0 wt. % of HPC of Comparative Example 5 was prepared in the same manner as described above for the modified release formulation of Example 7 using the ingredients in amounts listed in Table 4 above.

Dissolution testing of the tablets of Examples 7 and 7A was performed in the same manner as described above in Examples 6 and 6A at the dose of 50 mg using USP Apparatus I in 0.05 M phosphate at pH=6.8 and at a constant stirring speed of 100 RPM. FIG. 3 shows the dissolution profile of Hydrochlorothiazide (HCTZ) as a % of the total drug released over 24 hours for both the formulations i.e. Ex. 7 and Ex. 7A. It is evident from FIG. 3 that the drug release from the modified release formulation of Example 7 was slower than the comparative modified release formulation of Example 7A.

### Example 8

### Modified Release Formulation (Ex. 8) having 20 wt. % HPC of Example 2

In this example, modified release formulation tablets (Ex. 8) of individual tablet weight of approximately 860 mg were prepared using 20 wt. % HPC of Example 2. The modified release formulation (Ex. 8) of this example was prepared in the same manner as described above in Example 6 using the ingredient in amounts listed in Table 5 below.

TABLE 5
Modified release formulations of Examples 8 and 8A

| | | Ex. 8 | | Ex. 8A | |
|---|---|---|---|---|---|
| | | Amount of Ingredients | | Amount of Ingredients | |
| | | % w/w (based | (mg) based on | % w/w (based | (mg) based on |
| | | on 100 wt. % | individual | on 100 wt. % | individual |
| S. | | of a dry tablet | tablet weight | of a dry tablet | tablet weight |
| No. | Ingredients | composition) | of 860 mg | composition) | of 860 mg |
| 1 | Ibuprofen | 70.0 | 602.0 | 70.0 | 602.0 |
| 2 | HPC of Ex. 2 | 20.0 | 172.0 | Nil | Nil |
| | HPC of Comp. Ex. 5 | Nil | Nil | 20.0 | 172.0 |
| 3 | Spray Dried Lactose | 8.5 | 73.1 | 8.5 | 73.1 |
| 4 | Sodium Stearyl Fumarate | 0.5 | 4.3 | 0.5 | 4.3 |
| 5 | Colloidal silicon dioxide | 0.5 | 4.3 | 0.5 | 4.3 |
| 6 | Magnesium Stearate | 0.5 | 4.3 | 0.5 | 4.3 |
| | Total | 100 | 860 | 100 | 860 |

### Example 8A

### Comparative Modified Release Formulation (Ex. 8A) having 20 wt. % HPC of Comparative Example 5

A comparative modified release formulation (Ex. 8A) comprising 20.0 wt. % HPC of Comparative Example 5 was prepared in the same manner as described above for the modified release formulation of Example 8 using the ingredients in amounts listed in Table 5 above.

Dissolution testing of the tablets of Examples 8 and 8A was carried out in the same manner as described above in Examples 6 and 6A at the dose of 60 mg using USP Apparatus I in 0.05 M phosphate at pH=7.2 and at a constant stirring speed of 100 RPM. The samples were analyzed by inline UV detection at 221 nm. FIG. 4 shows the dissolution profile of Ibuprofen as a % of the total drug released over 24 hours for both the formulations i.e. Ex. 8 and Ex. 8A. The drug release from the modified release formulation of Example 8 was slower than the drug release from the comparative modified release formulation of Example 8A.

### Example 9

### Modified Release Formulation (Ex. 9) having 10 wt. % HPC of Example 2

Similar to the formulation of Example 8, this example describes a preparation of modified release formulation with individual tablet weight of approximate 860 mg using the same ingredients and procedure as described in Example 8, except that 10 wt. %. HPC of Example 2 was used. Accordingly, the weight proportion of other ingredients were adjusted and listed in Table 6 below.

TABLE 6
Modified release formulations of Examples 9 and 9A

| | | Ex. 9 | | Ex. 9A | |
|---|---|---|---|---|---|
| | | Amount of Ingredients | | Amount of Ingredients | |
| | | % w/w (based | (mg) based on | % w/w (based | (mg) based on |
| | | 100 wt. % | individual | 100 wt. % | individual |
| S. | | of a dry tablet | tablet weight | of a dry tablet | tablet weight |
| No. | Ingredients | composition) | of 860 mg | composition) | of 860 mg |
| 1 | Ibuprofen | 70.0 | 602.0 | 70.0 | 602.0 |
| 2 | HPC of Ex . 2 | 10.0 | 86.0 | Nil | Nil |
| | HPC of Comp. Ex. 5 | Nil | Nil | 10 | 86.0 |
| 3 | Spray Dried Fructose | 18.5 | 159.1 | 18.5 | 159.1 |
| 4 | Sodium Stearyl Fumarate | 0.5 | 4.3 | 0.5 | 4.3 |
| 5 | Colloidal silicon dioxide | 0.5 | 4.3 | 0.5 | 4.3 |
| 6 | Magnesium Stearate | 0.5 | 4.3 | 0.5 | 4.3 |

| | | | | |
|---|---|---|---|---|
| Total | 100 | 860 | 100 | 860 |

### Example 9A

### Comparative Modified Release Formulation (Ex. 9A) having 10 wt. % HPC of Comparative Example 5

A comparative modified release formulation (Ex. 9A) comprising 10.0 wt. % of HPC of Comparative Example 5 was prepared in the same manner as described above for the modified release formulation of Example 9 using the ingredients in amounts listed in Table 6 above.

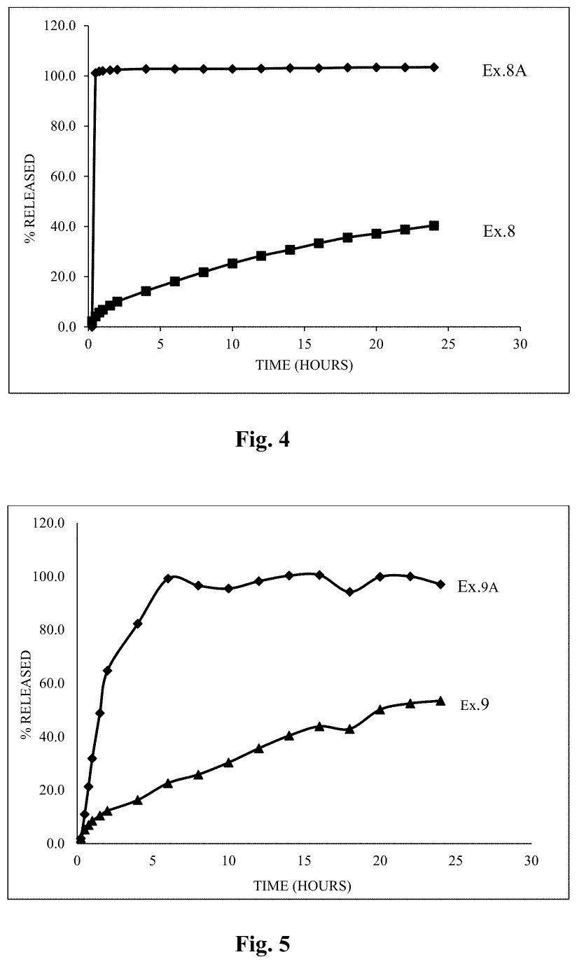

Dissolution testing of the tablets of Examples 9 and 9A was performed at the dose of 600 mg using USP Apparatus I in 0.05 M phosphate at pH=7.2 using the same procedure as described above in Examples 6 and 6A. The samples were analyzed by inline UV detection at 221 nm. FIG. 5 shows the dissolution profile of Ibuprofen as a % of total drug released over 24 hours for both the formulations, Ex. 9 and Ex. 9A. The drug release from the modified release formulation of Example 9 was slower than the drug release from the comparative modified release formulation of Example 9A.

### Example 10

### Modified Release Formulation (Ex. 10) having 25 wt. % HPC of Example 2

In this example, modified release formulation tablets (Ex. 10) of individual tablet weight of approximately 500 mg were prepared using 25 wt. % HPC of Example 2. The modified release formulation (Ex. 10) of this example was prepared using the ingredient in amounts listed in Table 7 below and in the same manner as described above in Example 6.

TABLE 7
Modified release formulations of Examples 10 and 10A

| | | Ex. 10 | | Ex. 10 A | |
|---|---|---|---|---|---|
| | | Amount of Ingredients | | Amount of Ingredients | |
| | | % w/w (based | (mg) based on | % w/w (based | (mg) based on |
| | | on 100 wt. % | individual | 100 wt. % | individual |
| S. | | of a dry tablet | tablet weight | of a dry tablet | tablet weight |
| No. | Ingredients | composition) | of 500 mg | composition) | of 500 mg |
| 1 | Ibuprofen | 10.0 | 50.0 | 10.0 | 50.0 |
| 2 | HPC of Ex. 2 | 25.0 | 125.0 | Nil | Nil |
| | HPC of Comp. Ex. 5 | Nil | Nil | 25.0 | 125.0 |
| 3 | Microcrystalline Cellulose | 63.5 | 317.5 | 63.5 | 317.5 |
| 4 | Sodium Stearyl Fumarate | 0.5 | 2.5 | 0.5 | 2.5 |
| 5 | Colloidal silicon dioxide | 0.5 | 2.5 | 0.5 | 2.5 |
| 6 | Magnesium Stearate | 0.5 | 2.5 | 0.5 | 2.5 |
| | Total | 100 | 500 | 100 | 500 |

### Example 10A

### Comparative Modified Release Formulation (Ex. 10 A) having 25 wt. % HPC of Comparative Example 5

A comparative modified release formulation (Ex. 10A) comprising 25.0 wt. % of HPC of Comparative Example 5 was also prepared in the same manner as described above for the modified release formulation of Example 10 using the ingredients in amounts listed in Table 7 above.

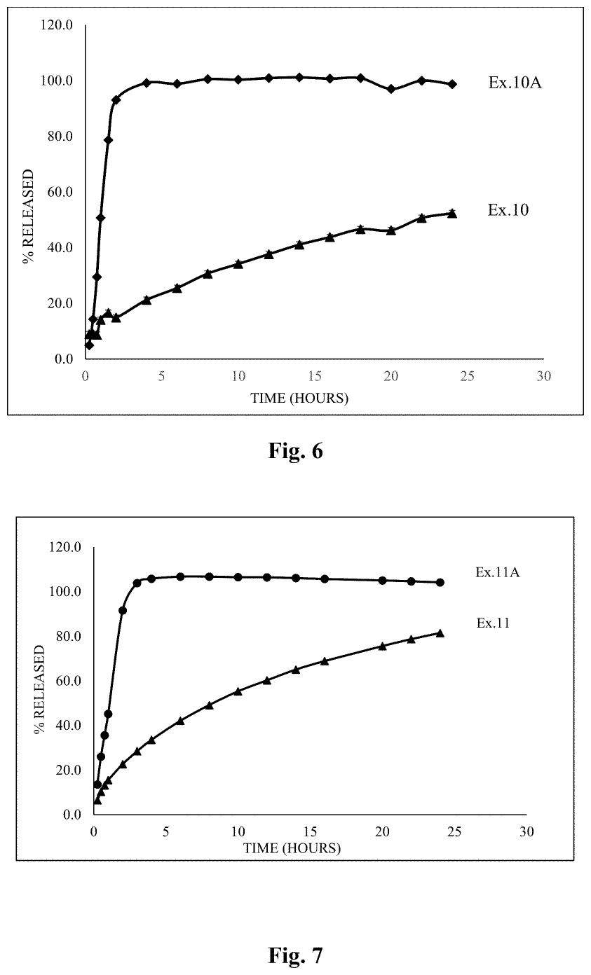

Dissolution testing of the tablets of Examples 10 and 10A was performed at the dose of 600 mg using USP Apparatus I in 0.05 M phosphate at pH=7.2 and at a constant stirring speed of 100 RPM in the same manner as describe above in Examples 6 and 6A. The samples were analyzed by inline UV detection at 221 nm. FIG. 6 shows the dissolution profile of Ibuprofen as a % of the total drug released over 24 hours for both the formulations i.e. Ex. 10 and Ex. 10A. The drug release from the modified release formulation of Example 10 was slower than the drug release from the comparative modified release formulation of Example 10A.

### Example 11

### Modified Release Formulation (Ex. 11) having 15 wt. % HPC of Example 3

Modified release formulation tablets with individual tablet weight of approximately 500 mg were prepared in this example using 15 wt. % HPC of Example 3. The tablets were prepared in the same manner as described above in Example 6 using the ingredients in amounts listed in Table 8 below.

TABLE 8
Modified release formulations of Examples 11 and 11A

| | | Ex. 11 | | Ex. 11A | |
|---|---|---|---|---|---|
| | | Amount of Ingredients | | Amount of Ingredients | |
| | | % w/w (based | (mg) based on | % w/w (based | (mg) based on |
| | | on 100 wt. % | individual | on 100 wt. % | individual |
| S. | | of a dry tablet | tablet weight | of a dry tablet | tablet weight |
| No. | Ingredients | composition) | of 500 mg | composition) | of 500 mg |
| 1 | Hydrochlorothiazide | 10.0 | 50.0 | 10.0 | 50.0 |
| 2 | HPC of Ex. 3 | 15.0 | 75.0 | Nil | Nil |
| | HPC of Comp. Ex. 5 | Nil | Nil | 15.0 | 75.0 |
| 3 | Spray Dried Lactose | 33.5 | 167.5 | 33.5 | 167.5 |
| 4 | Microcrystalline cellulose | 40.0 | 200.0 | 40.0 | 200.0 |
| 5 | Sodium Stearyl Fumarate | 0.5 | 2.5 | 0.5 | 2.5 |
| 6 | Colloidal silicon dioxide | 0.5 | 2.5 | 0.5 | 2.5 |
| 7 | Magnesium Stearate | 0.5 | 2.5 | 0.5 | 2.5 |
| | Total | 100 | 500 | 100 | 500 |

### Example 11A

### Comparative Modified Release Formulation (Ex. 11A) having 15 wt. % HPC of Comparative Example 5

A comparative modified release formulation (Ex. 11A) comprising15.0 wt. % of HPC of Comparative Example 5 was prepared in the same manner as described above for the modified release formulation of Example 11 using the ingredients in amounts listed in Table 8 above.

Dissolution testing of the tablets of Examples 11 and 11A was performed at the dose of 50 mg using USP Apparatus I in 0.15 M phosphate at pH=6.8 and at a constant stirring speed of 100 RPM in the same manner as describe above in Example 6. The dissolution profile of the modified release formulation of Example 11 (Ex. 11) was shown in FIG. 7 and compared with the dissolution profile of the comparative modified release formulation of Example 11A. The drug release from the modified release formulation of Example 11 (Ex. 11) was slower than the drug release from the comparative modified release formulation of Example 11A (Ex. 11A).

### Example 12

### Modified Release Formulation (Ex. 12) having 15 wt. % of HPC of Example 4.

Modified release formulation tablets with individual tablet weight of approximately 500 mg were prepared in this example using 15 wt. % HPC of Example 4. The tablets were prepared in the same manner as described above in Example 6 using the ingredients in amounts listed in Table 9 below.

TABLE 9
Modified release formulation of Example 12

| | | Ex. 12 | | Ex. 11A | |
|---|---|---|---|---|---|
| | | Amount of Ingredients | | Amount of Ingredients | |
| | | % w/w (based | (mg) based on | % w/w (based | (mg) based on |
| | | on 100 wt. % | individual | on 100 wt. % | individual |
| S. | | of a dry tablet | tablet weight | of a dry tablet | tablet weight |
| No. | Ingredients | composition) | of 500 mg | composition) | of 500 mg |
| 1 | Hydrochlorothiazide | 10.0 | 50.0 | 10.0 | 50.0 |
| 2 | HPC of Ex. 4 | 15.0 | 75.0 | Nil | Nil |
| | HPC of Comp. Ex. 5 | Nil | Nil | 15.0 | 75.0 |
| 3 | Spray Dried Lactose | 33.5 | 167.5 | 33.5 | 167.5 |
| 4 | Microcrystalline cellulose | 40.0 | 200.0 | 40.0 | 200.0 |
| 5 | Sodium Stearyl Fumarate | 0.5 | 2.5 | 0.5 | 2.5 |
| 6 | Colloidal silicon dioxide | 0.5 | 2.5 | 0.5 | 2.5 |
| 7 | Magnesium Stearate | 0.5 | 2.5 | 0.5 | 2.5 |
| | Total | 100 | 500 | 100 | 500 |

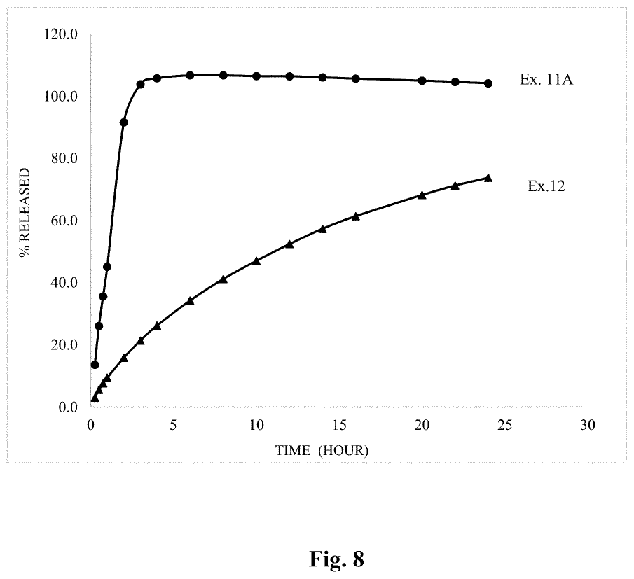

Dissolution testing of the tablets of this example was performed at the dose of 50 mg using USP Apparatus I in 0.15 M phosphate at pH=6.8 and at a constant stirring speed of 100 RPM in the same manner as describe above in Example 6. The samples were analyzed by inline UV detection at 272 nm. The dissolution profile of the modified release formulation of Example 12 (Ex. 12) was shown in FIG. 8 and compared with the dissolution profile of the control modified release formulation Ex. 11A. The drug release from the modified release formulation of Example 12 was slower than the drug release from the comparative modified release formulation of Example 11A.

What is claimed is:

1. A hydroxypropyl cellulose having a molar substitution of from about 3.0 to about 3.9, a weight average molecular weight of from about 700,000 to about 2,000,000 Daltons, and a volume average particle size of less than 100 μm.

2. The hydroxypropyl cellulose of claim 1, wherein the molar substitution is of from about 3.2 to about 3.8.

3. The hydroxypropyl cellulose of claim 1, wherein the molar substitution is of from about 3.4 to about 3.7.

4. The hydroxypropyl cellulose of claim 1, wherein the weight average molecular weight varies in the range of from 1,000,000 to 1,500,000 Daltons.

5. The hydroxypropyl cellulose of claim 1, wherein the hydroxypropyl cellulose has a viscosity of at least 300 mPa·s in a 1 wt. % aqueous solution at 25° C.

6. The hydroxypropyl cellulose of claim 1, wherein the viscosity varies in the range of from about 1,000 to about 3000 mPa·s in a 1% aqueous solution at 25° C.

7. A modified release formulation comprising hydroxypropyl cellulose having a molar substitution of from about 3.0 to about 3.9, a weight average molecular weight of from about 700,000 to about 2,000,000 Daltons, and a volume average particle size of less than 100 μm.

8. The modified release formulation of claim 7, wherein the molar substitution is of from about 3.2 to about 3.8.

9. The modified release formulation of claim 7, wherein the molar substitution is of from about 3.4 to about 3.7.

10. The modified release formulation of claim 7, wherein the hydroxypropyl cellulose is present in the range of from about 5 wt. % to about 99 wt. % of the total formulation.

11. The modified release formulation of claim 7, wherein the hydroxypropyl cellulose is present in the range of from about 10 wt. % to about 90 wt. % of the total formulation.

12. The modified release formulation of claim 7, wherein the hydroxypropyl cellulose is present in the range of from about 15 wt. % to about 75 wt. % of the total formulation.

13. The modified release formulation of claim 7, wherein the hydroxypropyl cellulose has a viscosity of at least 300 mPa·s in a 1 wt. % aqueous solution at 25° C.

14. The modified release formulation of claim 7, wherein the hydroxypropyl cellulose has a viscosity in the range of from about 1,000 to 3,000 mPa·s in a 1 wt. % aqueous solution at 25° C.

15. The modified release formulation of claim 7, further comprising a pharmaceutically effective amount of at least one drug having water solubility greater than 1 mg/L at 25° C.

16. The modified release formulation of claim 15, wherein the water solubility of the drug is greater than 20 mg/L.

17. The modified release formulation of claim 15, wherein the water solubility of the drug is greater than 700 mg/L.

18. The modified release formulation of claim 15, wherein the drug is selected from the group consisting of antipyretic drugs, analgesic drugs, anti-inflammatory drugs, anthelmintic drugs, cardiovascular drugs, antibacterial drugs, bronchodilating drugs, anti-asthmatic drugs, gastrointestinal drugs, antidiabetic drugs, antiprotozoal drugs, antiviral drugs, anti-epileptic drugs, anti-diuretic drugs, and its pharmaceutically acceptable salts and esters thereof.

19. The modified release formulation of claim 15, wherein the drug is selected from the group consisting of etodolac, albendazole, ciprofloxacin, erythromycin and its derivative, ibuprofen, diclofenac, tofacitinib, carvedilol, metoprolol, sacubitril, valsartan, salbutamol, doxofylline, theophylline, cimetidine, omeprazole, metformin hydrochloride, sitagliptin, tinidazole, chlorothiazide, hydrochlorothiazide, acyclovir, carbamazepine, and its pharmaceutically acceptable salts and esters thereof.

20. The modified release formulation of claim 7, further comprising at least one pharmaceutically acceptable excipient selected from the group consisting of a filler, a binder, a surfactant, a disintegrating agent, a lubricant, and a flow aid.

21. The modified release formulation of claim 20, wherein the filler is selected from the group consisting of monosaccharides, disaccharides, polysaccharides, inorganic acid salts and combinations thereof.

22. The modified release formulation of claim 20, wherein the filler is selected from the group consisting of cellulose, lactose, sucrose, sugars, starches, processed starches, mannitol, sorbitol, xylitol, lactitol, silicic acid, calcium sulfate, aluminum and magnesium silicate complexes and oxides, calcium diphosphate dihydrate and hydrosulfates.

23. The modified release formulation of claim 20, wherein the lubricant is selected from the group consisting of talc, calcium stearate, magnesium stearate, polyethylene glycol, stearic acid, palmitic acid, colloidal silicon dioxide, calcium silicate, mineral oils, wax, carnauba wax hydrogenated vegetable oils, glyceryl behenate, sodium benzoate, sodium acetate, and sodium stearyl fumarate, sucrose fatty acid esters of stearic acid, palmitic acid, myristic acid, oleic acid, lauric acid, behenic acid, erucic acid, and any combinations thereof.

24. The modified release formulation of claim 20, wherein the binder is selected from the group consisting of polyvinyl pyrrolidone, sucrose, lactose, starch, processed starch, sugars, gum Arabic, tragacanth gum, guar gum, pectin, wax-based binders, microcrystalline cellulose, methyl cellulose, carboxymethyl cellulose, copovidone, gelatin, sodium alginate hydroxypropyl methyl cellulose, hydroxyethyl cellulose, and any combinations thereof.

25. The modified release formulation of claim 20, wherein the pharmaceutically acceptable excipient is present in an amount of from about 1 wt. % to about 85 wt. % of the total formulation.

26. The modified release formulation of claim 7, wherein the formulation is in the form of a tablet, a capsule, powder, granules, sachets, or lozenges.
